(19) United States
(12) Patent Application Publication
(10) Pub. No.: US 2026/0051216 A1
(43) Pub. Date: Feb. 19, 2026

(54) CRANE GAME MACHINE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(21) Appl. No.: 18/957,165

(22) Filed: Nov. 22, 2024

(30) Foreign Application Priority Data
Aug. 13, 2024 (TW) 113130353

(51) Int. Cl. G07F 17/32

(52) U.S. Cl. CPC G07F 17/3216; G07F 17/3295; G07F 17/3297; G07F 17/3253

(57) ABSTRACT

A crane game machine includes a cabinet, an operation unit, and an operation interface. The operation unit includes a bridge crane mechanism, a gripper mechanism that is movably mounted to the bridge crane mechanism, and a crane motor that is connected to the gripper mechanism. The crane motor is operable for urging the gripper mechanism to undertake a lowering journey in which the gripper mechanism is moved downwardly, and a lifting journey in which the gripper mechanism is moved upwardly. At least one of the lowering journey and the lifting journey is divided into a plurality of subsections. A moving speed of the gripper mechanism in one of the plurality of subsections is different from the moving speed of the gripper mechanism in at least another one of the plurality of subsections. The operation interface is operable for urging the bridge crane mechanism to drive movement of the gripper mechanism.

### CROSS-REFERENCE TO RELATED APPLICATION

This application claims priority to Taiwanese Invention Patent Application No. 113130353, filed on Aug. 13, 2024, the entire disclosure of which is incorporated by reference herein.

### FIELD

The present disclosure relates to an electronic gaming machine, and more particularly to a crane game machine that can be used for various types of prizes with each type of prizes weighing differently from other types of prizes.

### BACKGROUND

Referring to FIG. 1, a conventional crane game machine 1 includes a cabinet 10 that defines an inner space 100 which is adapted for containing a plurality of prizes (not shown), a grip claw mechanism 11 that is disposed in the inner space 100 and that is adapted for gripping the prizes, and an operation interface 12 that is connected to the cabinet 10 and that is operable to urge the grip claw mechanism 11 to move. The prizes disposed in the inner space 100 are not limited, and vary in appearance, weight, density, and so on. After an owner of the conventional crane game machine 1 decides on the prizes to be placed in the inner space 100, in addition to specifications of the grip claw mechanism 11, the owner also has to adjust parameter settings of a gripping force, motion sensitivity, a lowering speed, a lifting speed, etc. of the grip claw mechanism 11 according to characteristics of the prizes. Thus, while ensuring that the grip claw mechanism 11 is capable of gripping the prizes, the owner also has to strike a balance between attracting customers and making profits.

Currently, because the market of related games is becoming increasingly competitive, it is common practice for the prizes to be replaced frequently to reflect the market demand. However, when the prizes of one weight are replaced with prizes of a different weight, it is troublesome for the owner to choose which size of the grip claw mechanism 11 or which gripping force of the grip claw mechanism 11 to replace the initial grip claw mechanism 11 with. Particularly, any adjustment to the lowering speed and the lifting speed of the grip claw mechanism 11 according to the weights of the prizes affects lifting and lowering movements of the grip claw mechanism 11, and may even affect how the grip claw mechanism 11 throws the prizes. The lifting and lowering movements of the grip claw mechanism 11 and how the grip claw mechanism 11 throws the prizes are crucial factors in players' willingness to play. Because the lowering speed and the lifting speed of the grip claw mechanism 11 can only be set at a constant numerical value, even if the specifications of the grip claw mechanism 11 suit the weights of the prizes, it may still be difficult for the grip claw mechanism 11 to generate a specific operational movement according to the weights of the prizes. Therefore, the owner may not be able to strike a proper balance between attracting customers and making profits. As a result, the conventional crane game machine 1 still does not accommodate the need of having various types of prizes with different weights.

### SUMMARY

Therefore, an object of the disclosure is to provide a crane game machine that can alleviate at least one of the drawbacks of the prior art.

According to the disclosure, the crane game machine includes a cabinet, an operation unit, and a control unit. The cabinet defines an interior space. The operation unit is disposed in the interior space, and includes a bridge crane mechanism that is mounted to a top portion of the interior space, a gripper mechanism that is movably mounted to the bridge crane mechanism, and a crane motor that is connected to the gripper mechanism. The crane motor is operable for urging the gripper mechanism to undertake a lowering journey in which the gripper mechanism is moved downwardly, and a lifting journey that follows the lowering journey and in which the gripper mechanism is moved upwardly. At least one of the lowering journey and the lifting journey is divided into a plurality of subsections. A moving speed of the gripper mechanism in one of the plurality of subsections is different from the moving speed of the gripper mechanism in at least another one of the plurality of subsections. The control unit is informationally connected to the operation unit, and includes an operation interface and a setting interface. The operation interface is operable for urging the bridge crane mechanism to drive movement of the gripper mechanism, and for sending a claw-lowering command to the crane motor so that the crane motor starts to urge the gripper mechanism to undertake the lowering journey. The setting interface is informationally connected to the crane motor and is operable for setting the moving speed of the gripper mechanism in each of the plurality of subsections of the at least one of the lowering journey and the lifting journey.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a front view of a conventional crane game machine.

FIG. 2 is a schematic view illustrating an embodiment of a crane game machine according to the disclosure.

FIG. 3 is a fragmentary, enlarged front view illustrating a gripper mechanism of an operation unit of the embodiment.

FIG. 4 is a perspective view illustrating a limitation plate of the gripper mechanism.

FIG. 5 is a speed-time graph illustrating a lifting journey of the gripper mechanism under a circumstance that the embodiment contains heavy prizes.

FIG. 6 is a speed-time graph illustrating another lifting journey of the gripper mechanism under a circumstance that the embodiment contains light prizes.

FIG. 7 is a schematic view, in cooperation with FIG. 2, illustrating a setting interface of a control unit of the embodiment adjusting a moving speed of the gripper mechanism according to a predetermined distance between an initial position of the gripper mechanism and a bottom plate of the embodiment.

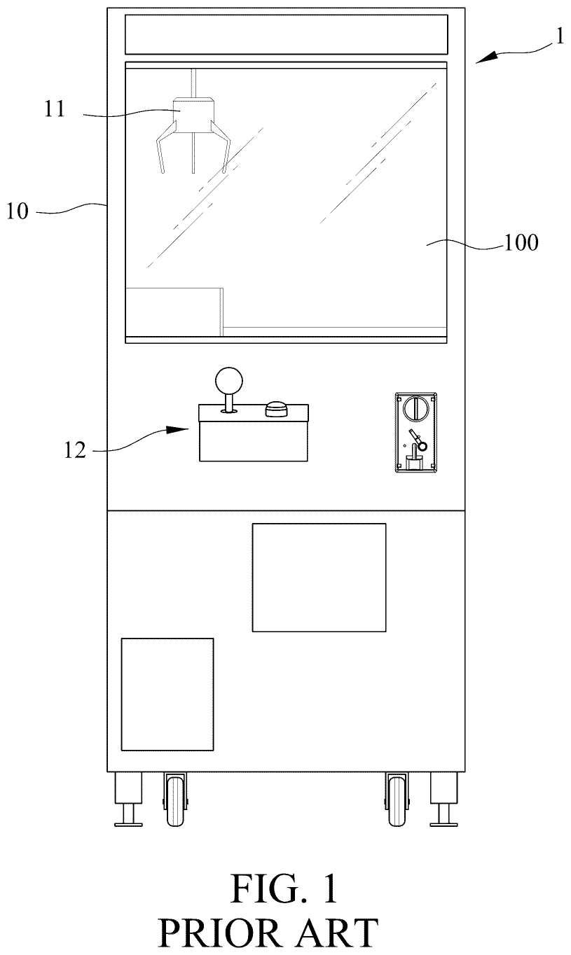

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

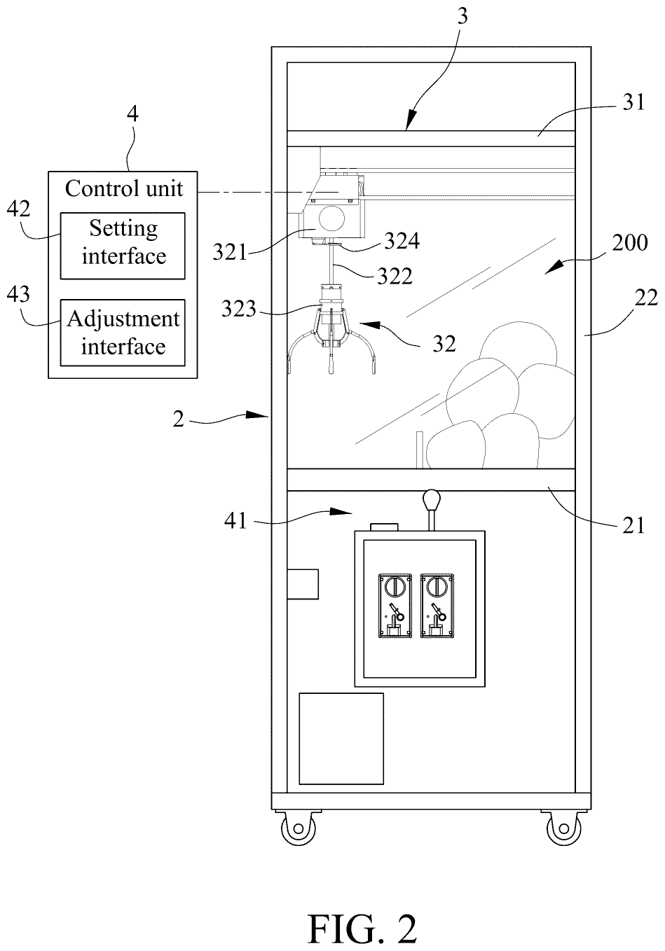

Referring to FIG. 2, an embodiment of a crane game machine according to the present disclosure is adapted for picking up various types of prizes with each type of prizes weighing differently from other types of prizes, and includes a cabinet 2 that defines an interior space 200, an operation unit 3 that is disposed in the interior space 200, and a control unit 4 that is informationally connected to the operation unit 3. It is noted that, the cabinet 2 and the operation unit 3 are generally physical equipment, and the control unit 4 is an assembly of hardware, software, and firmware that performs a variety of tasks on the operation unit 3, such as controlling, operating, adjusting, and setting the operation unit 3, and so on.

The cabinet 2 includes a bottom plate 21, and a surrounding wall 22 that extends upwardly from a periphery of the bottom plate 21 and that cooperates with the bottom plate 21 to define the interior space 200. The interior space 200 is adapted for an owner of the crane game machine to freely place various prizes therein. Furthermore, because details of a configuration of a prize outlet, an arrangement of a blocking plate for the prize outlet, a window switch, etc. are not important aspects of the present disclosure, and may be understood by one skilled in the art, descriptions thereof are omitted.

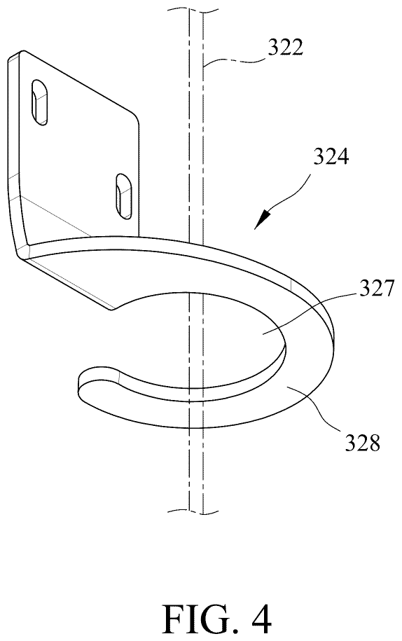

Referring to FIGS. 2, 3, and 4, the operation unit 3 includes a bridge crane mechanism 31 that is mounted to a top portion of the interior space 200, a gripper mechanism 32 that is movably mounted to the bridge crane mechanism 31, and a crane motor 33 that is connected to the gripper mechanism 32. An initial position of the gripper mechanism 32 is spaced apart from the bottom plate 21 of the cabinet 2 by a predetermined distance. The predetermined distance is for relevant setting requirements, and is a consideration for the owner to decide what sizes of the prizes are suitable therefor.

The gripper mechanism 32 has a main body portion 321, a pull rope 322 that is connected to the crane motor 33, a claw portion 323 that is connected to the pull rope 322, and a limitation plate 324 that is disposed below the main body portion 321. The limitation plate 324 defines a through hole 327 through which the pull rope 322 extends, and has an abutment surface 328 that faces downwardly and that is inclined relative to an imaginary horizontal plane (not shown). The limitation plate 324 has a function of protecting the main body portion 321 from being hit directly by the claw portion 323. Therefore, when the claw portion 323 moves upwardly, even if the crane motor 33 does not stop at the right time, the claw portion 323 only hits the abutment surface 328 of the limitation plate 324 which is replaceable, and does not hit the main body portion 321.

It is noted that the crane motor 33 rotates at a rotation speed to wind or unwind the pull rope 322 that is connected to the claw portion 323 so that the claw portion 323 is urged to move at a moving speed which corresponds to the rotation speed. The rotation speed of the crane motor 33 has a positive correlation with an operating torque of the crane motor 33. Therefore, the faster the crane motor 33 winds the pull rope 322, the faster the claw portion 323 is moved upwardly. When the claw portion 323 grips an object, a higher rotation speed of the crane motor 33 generates a larger pulling force to pull the object that is gripped by the claw portion 323.

The crane motor 33 is operable for urging the gripper mechanism 32 to undertake a lowering journey in which the gripper mechanism 32 is moved downwardly, and a lifting journey that follows the lowering journey and in which the gripper mechanism 32 is moved upwardly. The control unit 4 includes an operation interface 41, a setting interface 42, and an adjustment interface 43. The operation interface 41 is operable for urging the bridge crane mechanism 31 to drive movement of the gripper mechanism 32, and for sending a claw-lowering command to the crane motor 33 so that the crane motor 33 starts to urge the gripper mechanism 32 to undertake the lowering journey. The setting interface 42 is informationally connected to the crane motor 33, and is operable for setting a moving speed of the gripper mechanism 32. The adjustment interface 43 is operable for adjusting a gripping force of the gripper mechanism 32 when the gripper mechanism 32 is in the lifting journey.

It is noted that, during the lowering journey of the gripper mechanism 32, when a player of the crane game machine operates the operation interface 41 of the control unit 4 such that the operation interface 41 sends a gripping command to the gripper mechanism 32, the gripper mechanism 32 urges the claw portion 323 to close and then the gripper mechanism 32 undertakes the lifting journey after the claw portion 323 is urged to close. However, during the lowering journey of the gripper mechanism 32, if the operation interface 41 does not send the gripping command to the gripper mechanism 32 according to the player's operation, the gripper mechanism 32 will urge the claw portion 323 to close by the gripping force thereof when one of the three conditions is met, and then the gripper mechanism 32 will undertake the lifting journey after the claw portion 323 is urged to close, where the three conditions include the claw portion 323 being lowered by a certain distance, the claw portion 323 touching any one of the prizes, and the claw portion 323 touching the bottom plate 21.

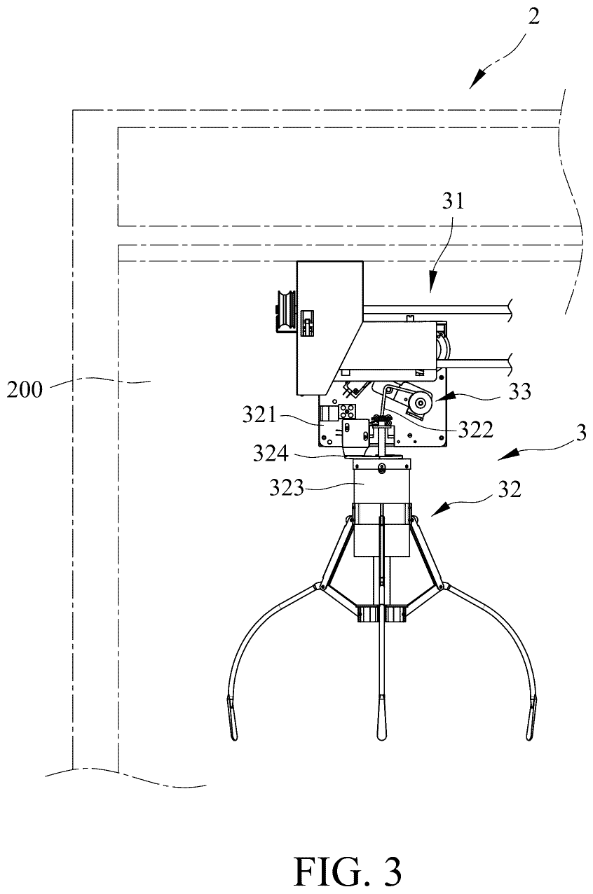

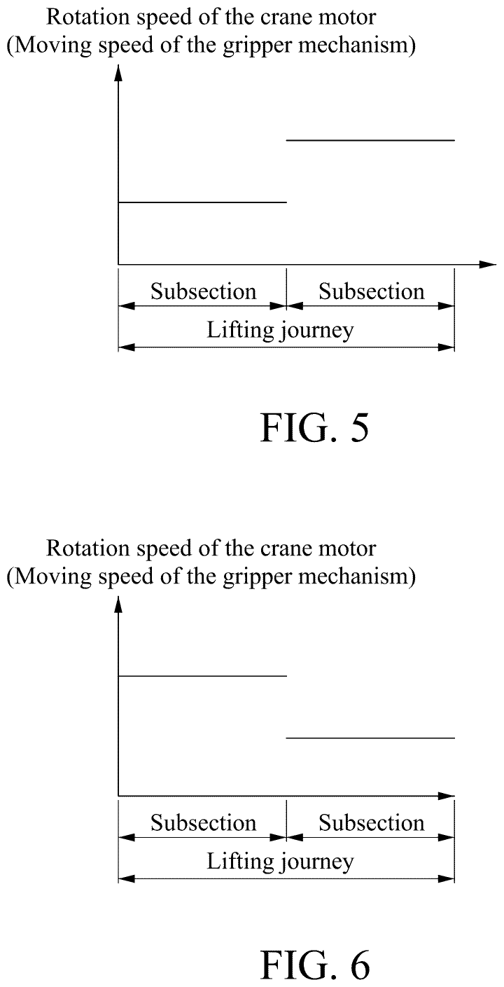

The lifting journey of the gripper mechanism 32 is taken as an example to illustrate an actual operation of the present embodiment below. The lifting journey is divided into a plurality of subsections that are arranged in order, and a plurality of stages that are arranged in order. The moving speed of the gripper mechanism 32 in one of the subsections is different from the moving speed of the gripper mechanism 32 in at least another one of the subsections. The gripping force of the gripper mechanism 32 in one of the stages is different from the gripping force of the gripper mechanism 32 in at least another one of the stages. The setting interface 42 is informationally connected to the crane motor 33 so that the setting interface 42 is operable for setting the moving speed of the gripper mechanism 32 in each of the subsections of the lifting journey. It is noted that, the moving speed of the gripper mechanism 32 in each of the subsections of the lifting journey means an average speed of the gripper mechanism 32 in each of the subsections of the lifting journey. Referring to FIG. 5, in cooperation with FIGS. 2 and 3, the moving speed of the gripper mechanism 32 is represented by the rotation speed of the crane motor 33, which is represented by the vertical axis. The following describes a condition where the prizes in the interior space 200 are relatively heavy. Because magnitude of the gripping force of the gripper mechanism 32 determines whether the claw portion 323 may securely grip one of the heavy prizes at the moment the claw portion 323 closes, the one of the heavy prizes may be securely gripped as long as the gripping force of the gripper mechanism 32 in a first one of the stages of the lifting journey is set to be sufficient. Then, if the lifting journey has two subsections, which are represented by the horizontal axis, in order to prevent the one of the heavy prizes from slipping out of the claw portion 323 of the gripper mechanism 32 at the beginning of the lifting journey of the gripper mechanism 32 when the moving speed of the gripper mechanism 32 is too high, the gripper mechanism 32 is set to move slower in a first one of the subsections than in a second one of the subsections which follows the first one of the subsections (i.e., the moving speed of the gripper mechanism 32 in the first one of the subsections is lower than the moving speed of the gripper mechanism 32 in the second one of the subsections). Thus, when the operating torque of the crane motor 33 is increased in a later subsection (i.e., the second one of the subsections) to urge the gripper mechanism 32 to move faster in the later subsection, the one of the heavy prizes has a higher chance to be gripped and moved to the initial position of the gripper mechanism 32 by the gripper mechanism 32.

It is noted that, generally, the gripping force of the gripper mechanism 32 in the first one of the stages of the lifting journey is adjusted to be sufficient according to weights of the prizes. However, in actual practice, the number of the stages of the lifting journey may be different from the number of the subsections of the lifting journey (e.g., one of the subsections may occupy the same period of time as two continuous ones of the stages do, or three continuous ones of the subsections may occupy the same period of time as two continuous ones of the subsection do), and the gripping forces of the gripper mechanism 32 may be respectively set to be different in the stages, thereby meeting requirements such as spinning and throwing the prizes, ensuring that at least one prize will be won, etc. Settings of the gripping forces of the gripper mechanism 32 in the stages of the lifting journey are not limited to the disclosure herein.

Referring to FIGS. 2, 3, and 6, the vertical axis and the horizontal axis in FIG. 6 respectively represent the vertical axis and the horizontal axis in FIG. 5, and the following describes a condition where the prizes in the interior space 200 are relatively light. If the prizes are light, it is more unlikely that one of the light prizes may slip out of the claw portion 323 of the gripper mechanism 32 at the very beginning of the lifting journey of the gripper mechanism 32. Therefore, if the lifting journey has two subsections, the gripper mechanism 32 is set to move faster in a first one of the subsections than in a second one of the subsections that follows the first one of the subsections (i.e., the moving speed of the gripper mechanism 32 in the first one of the subsections is greater than the moving speed of the gripper mechanism 32 in the second one of the subsections). Consequently, the claw portion 323 is prevented from rising too fast and hitting the limitation plate 324. In addition, when the claw portion 323 grips one of the light prizes that may be spun and thrown due to movement of the claw portion 323, the claw portion 323 is prevented from rising too fast in a later subsection (i.e., the second one of the subsections) so that the one of the light prizes may be prevented from being spun and thrown.

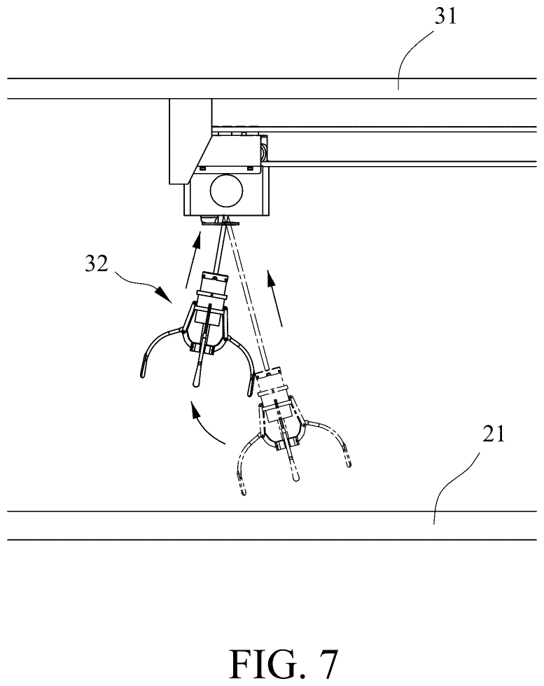

Referring to FIGS. 2 and 7, since one of the prizes has to be lifted by a certain distance by the gripper mechanism 32 when the one of the prizes is gripped by the gripper mechanism 32, in addition to setting a proper moving speed and a proper gripping force of the gripper mechanism 32 according to the weights of the prizes, the setting interface 42 may further set the moving speed of the gripper mechanism 32 in each of the subsections of the lifting journey according to the predetermined distance. Specifically, because the predetermined distance is a distance between the gripper mechanism 32 in the initial position and the bottom plate 21, the predetermined distance is also a distance that the gripper mechanism 32 travels in each of the lowering and lifting journeys. When the owner of the crane game machine takes into consideration a “swing technique” (i.e., a player may operate the operation interface to urge the pull rope 322 and the claw portion 323 to swing, or spin, so that the prize gripped by the gripper mechanism 32 may be thrown into the prize outlet, thereby allowing the player to win the prize) commonly employed by the players, in addition to setting the gripping forces of the gripper mechanism 32 in the stages properly, the owner may further set the moving speed of the gripper mechanism 32 in each of the subsections of the lifting journey according to the predetermined distance as well as the weights of the prizes via the setting interface 42 so that when the gripper mechanism 32 grips one of the prizes whose weight falls within a specific weight range specified by the owner, the pull rope 322 and the claw portion 323 may swing a specific number of times with a specific amplitude during the lifting journey of the gripper mechanism 32. For example, if the predetermined distance is 1 meter and the moving speed of the gripper mechanism 32 is initially set to be 25 centimeters per second, when the claw portion 323 is pulled upwardly and moved straight from the bottom plate 21, the claw portion 323 will return to its initial position in 4 seconds (i.e., the lifting journey of the gripper mechanism 32 takes 4 seconds). Based on this premise, a possible amplitude of the pull rope 322 and the claw portion 323 that corresponds to the weights of the prizes when the claw portion 323 grips one of the prizes may be set according to the operating torque of the crane motor 33 that corresponds to the moving speed (i.e., 25 centimeters per second) of the gripper mechanism 32. Then, further operation and calculation are conducted according to the possible amplitude for slightly adjusting the moving speed of the gripper mechanism 32 in each of the subsections of the lifting journey so that the claw portion 323 may be set to swing generally twice before returning to its initial position when the gripper mechanism 32 grips the one of the prizes and when the player employs the “swing technique.” Because the movement of the claw portion 323 is adjustable according to an adjustment to the moving speed of the gripper mechanism 32 in each of the subsections of the lifting journey, the crane game machine is suitable for having various types of prizes with each type of prizes weighing differently from other types of prizes, and the players may enjoy specific movements of the claw portion 323. As a result, the purpose of attracting high-level players is achieved.

In summary, by virtue of the setting interface 42 of the control unit 4 being informationally connected to the crane motor 33 and being operable for setting the moving speed of the gripper mechanism 32 via the crane motor 33, and by virtue of the adjustment interface 43 being operable for adjusting the gripping force of the gripper mechanism 32, the gripping force of the gripper mechanism 32 and the operating torque of the crane motor 33 may cooperate with each other so the crane game machine is suitable for having various types of prizes with each type of prizes weighing differently from other types of prizes. Furthermore, the movement of the gripper mechanism 32 when the gripper mechanism 32 grips one of the prizes is adjustable, thereby allowing the crane game machine to be more attractive to players (e.g., by adjusting the moving speed of the gripper mechanism 32 in each of the subsections of the lifting journey, throwing the one of the prizes gripped by the gripper mechanism 32 into the prize outlet may become easier, which makes the players think that their chances of winning are increased). Therefore, the purpose of the present disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A crane game machine comprising:
a cabinet defining an interior space;
an operation unit disposed in the interior space, and including a bridge crane mechanism that is mounted to a top portion of the interior space, a gripper mechanism that is movably mounted to the bridge crane mechanism, and a crane motor that is connected to the gripper mechanism, the crane motor being operable for urging the gripper mechanism to undertake a lowering journey in which the gripper mechanism is moved downwardly, and a lifting journey that follows the lowering journey and in which the gripper mechanism is moved upwardly, at least one of the lowering journey and the lifting journey being divided into a plurality of subsections, a moving speed of the gripper mechanism in one of the plurality of subsections being different from the moving speed of the gripper mechanism in at least another one of the plurality of subsections; and
a control unit informationally connected to the operation unit, and including
an operation interface that is operable for urging the bridge crane mechanism to drive movement of the gripper mechanism, and for sending a claw-lowering command to the crane motor so that the crane motor starts to urge the gripper mechanism to undertake the lowering journey; and
a setting interface that is informationally connected to the crane motor and that is operable for setting the moving speed of the gripper mechanism in each of the plurality of subsections of the at least one of the lowering journey and the lifting journey.

2. The crane game machine as claimed in claim 1, wherein the crane motor of the operation unit rotates at a rotation speed to urge the gripper mechanism to move at the moving speed that corresponds to the rotation speed, the rotation speed of the crane motor having a positive correlation with an operating torque of the crane motor.

3. The crane game machine as claimed in claim 2, wherein the lifting journey of the gripper mechanism is divided into the plurality of subsections that are arranged in order, and the gripper mechanism moves faster in one of the plurality of subsections than in another one of the plurality of subsections that follows the one of the plurality of subsections.

4. The crane game machine as claimed in claim 2, wherein the lifting journey of the gripper mechanism is divided into the plurality of subsections that are arranged in order, and the gripper mechanism moves slower in one of the plurality of subsections than in another one of the plurality of subsections that follows the one of the plurality of subsections.

5. The crane game machine as claimed in claim 1, wherein the cabinet includes a bottom plate, and a surrounding wall that extends upwardly from a periphery of the bottom plate and that cooperates with the bottom plate to define the interior space, an initial position of the gripper mechanism being spaced apart from the bottom plate by a predetermined distance, the setting interface of the control unit setting the moving speed of the gripper mechanism in each of the plurality of subsections of the at least one of the lowering journey and the lifting journey according to the predetermined distance.

6. The crane game machine as claimed in claim 5, wherein the lifting journey of the gripper mechanism is divided into the plurality of subsections that are arranged in order, and the gripper mechanism moves faster in one of the plurality of subsections than in another one of the plurality of subsections that follows the one of the plurality of subsections.

7. The crane game machine as claimed in claim 5, wherein the lifting journey of the gripper mechanism is divided into the plurality of subsections that are arranged in order, and the gripper mechanism moves slower in one of the plurality of subsections than in another one of the plurality of subsections that follows the one of the plurality of subsections.

8. The crane game machine as claimed in claim 1, wherein the control unit further includes an adjustment interface that is operable for adjusting a gripping force of the gripper mechanism when the gripper mechanism is in the lifting journey.

9. The crane game machine as claimed in claim 8, wherein the lifting journey of the gripper mechanism is divided into a plurality of stages, the gripping force of the gripper mechanism in one of the plurality of stages being different from the gripping force of the gripper mechanism in at least another one of the plurality of stages.

10. The crane game machine as claimed in claim 9, wherein the gripper mechanism of the operation unit has a main body portion, a pull rope that is connected to the crane motor, a claw portion that is connected to the pull rope, and a limitation plate that is disposed below the main body portion, the limitation plate defining a through hole through which the pull rope extends, and having an abutment surface that faces downwardly and that is inclined relative to an imaginary horizontal plane.

11. The crane game machine as claimed in claim 1, wherein the gripper mechanism of the operation unit has a main body portion, a pull rope that is connected to the crane motor, a claw portion that is connected to the pull rope, and a limitation plate that is disposed below the main body portion, the limitation plate defining a through hole through which the pull rope extends, and having an abutment surface that faces downwardly and that is inclined relative to an imaginary horizontal plane.
